(19) United States
(12) Patent Application Publication
(10) Pub. No.: US 2005/0161438 A1
(43) Pub. Date: Jul. 28, 2005

(54) Method for chemically removing aluminum-containing materials from a substrate

(76) Inventors: Lawrence Bernard Kool, Clifton Park, NY (US); James Anthony Ruud, Delmar, NY (US); Kenneth B. Potter, Pearland, TX (US); Myron Clyde Muth, West Charlton, NY (US); Ladd Sterling Laird, Spring, TX (US); Gabriel Ofori-Okai, Albany, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/035,327

(22) Filed: Jan. 13, 2005

Related U.S. Application Data
(62) Division of application No. 10/376,772, filed on Feb. 28, 2003, now abandoned.

(51) Int. Cl. B44C 1/22

(52) U.S. Cl. 216/102; 252/79.3

(57) ABSTRACT

A chemical composition for selectively removing an aluminum-containing material from a substrate comprises an acid having a formula of HₓAF₆, a precursor thereof, and a mixture of said acid and said precursor; wherein A is selected from the group consisting of Si, Ge, Ti, Zr, Al, and Ga; and x is in a range from 1 to 6, inclusive. The chemical composition can comprise at least another acid selected from the group consisting of phosphoric acid, nitric acid, sulfuric acid, hydrochloric acid, hydrofluoric acid, hydrobromic acid, hydriodic acid, acetic acid, perchloric acid, phosphorous acid, phosphinic acid, alkyl sulfonic acids, mixtures thereof, and precursors thereof. The chemical composition can be used to remove aluminum seal strips selectively from the dovetail of a turbine-engine blade.

### BACKGROUND OF THE INVENTION

The present invention relates to a method for chemically removing aluminum-containing materials from a substrate. In particular, the present invention relates to a chemical method for selectively removing aluminum or aluminum-containing materials from a substrate that comprises a metal alloy.

In a gas turbine engine, air is pressurized in a compressor and mixed with fuel in a combustor to generate hot combustion gases, which flow downstream through one or more turbines. The turbines convert chemical energy of the fuel to mechanical energy embodied in the rapid rotation of turbine blades, which mechanical energy in turn is converted to electrical energy by associated equipment. A turbine includes a row of circumferentially spaced apart turbine blades extending radially outwardly from a supporting rotor disk. Each blade typically includes a dovetail, which permits the blade to be assembled in and disassembled from a corresponding dovetail slot in the rotor disk. An airfoil extends radially outwardly from the dovetail. Hot combustion gases impinge on the airfoil to effect a high-speed rotational movement of the assembly of blades, by which rotational movement energy is extracted.

Turbine blades are typically made of a superalloy, such as a Ni- or Co-based alloy, and are typically coated with a protective coating comprising MCrAl(X), where M is an element selected from the group consisting of Ni, Co, Fe, and combinations thereof, and X is an element selected from the group consisting of Y, Ta, Si, Hf, Ti, Zr, B, C, and combinations thereof. In addition, in order to form a better seal between the dovetail of a blade and the corresponding dovetail slot in the rotor disk, strips of aluminum are typically disposed at the edges of the dovetail in the axial direction of the turbine.

It has become commonplace to repair turbine engine components, particularly airfoils, and return those components to service. During repair, any coatings, including the aluminum strips on the dovetail, are removed to allow inspection and repair of the underlying substrate. In addition, removal of the old aluminum seal strips from the dovetail is necessary in order to effect a good adherence of new seal strips to the substrate. Removal is typically carried out by immersing the component in a stripping solution containing an acid, such as a mixture of strong mineral acids (e.g., hydrochloric acid, sulfuric acid, nitric acid, hydrofluoric acid), as well as other additives.

However, some of the stripping compositions of the prior art do not remove sufficient amounts of the coatings. Further time and effort is thus required to complete the removal (e.g., by grit blasting), and this can in turn lead to a decrease in the efficiency of the repair process. On the other hand, some of the compositions that do sufficiently remove the coatings also attack the base metal of the substrate, pitting the base metal, or damaging the metal via intergranular boundary attack. Furthermore, conventional stripping solutions often emit an excessive amount of hazardous, acidic fumes. Due to environmental, health and safety concerns, such fumes must be scrubbed from ventilation exhaust systems.

Therefore, it is very desirable to provide a method for substantially removing aluminum-containing materials from a substrate without substantially attacking the substrate itself. It is also very desirable to provide a chemical solution that is capable of substantially removing aluminum-containing materials from a substrate comprising superalloy without substantially attacking the superalloy substrate.

### SUMMARY OF THE INVENTION

The present invention provides a chemical composition and a method for selectively removing aluminum-containing materials from a substrate.

In one aspect of the present invention, the chemical composition comprises an acid having the formula HₓAF₆, or precursors to said acid; wherein A is selected from the group consisting of Si, Ge, Ti, Zr, Al, and Ga; and x is 1-6, inclusive. The acid is typically present in a solution at a level in the range of about 0.05 M to about 5 M. In some preferred embodiments, the aqueous composition comprises the compound H₂SiF₆ or H₂ZrF₆. As described below, these compounds may sometimes be formed in situ from precursors thereof.

In another aspect of the invention, the chemical composition further comprises at least a second acid or precursor thereof. The second acid usually has a pH of less than about 7 in substantially pure water, and preferably, less than about 3.5; and can be chosen among a variety of acids. In one embodiment, the second acid is phosphoric acid.

In still another aspect of the invention, the chemical composition further comprises a third acid or precursor thereof. In one embodiment, the third acid is hydrochloric acid.

In one aspect of the present invention, the aluminum-containing materials have been disposed on or in a region near the surface of the substrate.

The present invention provides a chemical method for selectively removing an aluminum-containing material that is disposed on or in a region near a surface of a metal substrate. The method comprises contacting a work piece that comprises the substrate and the aluminum-containing material disposed thereon in a chemical composition comprising an acid having the formula HₓAF₆, or precursors to said acid; wherein A is selected from the group consisting of Si, Ge, Ti, Zr, Al, and Ga; and x is 1-6, inclusive.

In another aspect of the present invention, the chemical composition of the method further comprises a second acid.

In still another aspect of the present invention, the chemical composition of the method further comprises a third acid.

Other features and advantages of the present invention will be apparent from a perusal of the following detailed description of the invention and the accompanying drawings in which the same numerals refer to like elements.

### DESCRIPTION OF THE DRAWINGS

FIG. 1 is a perspective drawing of a turbine engine blade.

FIG. 2A shows light micrographs of a section of a dovetail of a used turbine-engine blade before treatment with a chemical composition of the present invention.

FIG. 2B shows light micrographs of the same section after treatment with a chemical composition of the present invention.

FIG. 3A shows light micrographs of top views of two different locations of a section of a dovetail of a used turbine-engine blade before treatment with a chemical composition of the present invention.

FIG. 3B shows light micrographs of side views of two different locations of a section of a dovetail of a used turbine-engine blade after treatment with a chemical composition of the present invention.

### DETAILED DESCRIPTION OF THE INVENTION

The present invention provides a chemical composition and a method for selectively removing aluminum-containing materials from a substrate. The aluminum-containing materials have been disposed on or in a region near a surface of a substrate. In particular, the chemical composition and the method of the present invention selectively remove aluminum seal strips disposed on surfaces of a dovetail of a gas turbine-engine blade. In the present disclosure, the expression “disposed on or in a region near a surface” is sometimes abbreviated to “disposed on a surface.” However, it should be understood that the abbreviated expression means that the aluminum-containing materials are disposed on a surface of the substrate, or are otherwise located in a region near the surface of the substrate, including the case in which the aluminum-containing materials are disposed on an intermediate layer that is in turn disposed on the substrate.

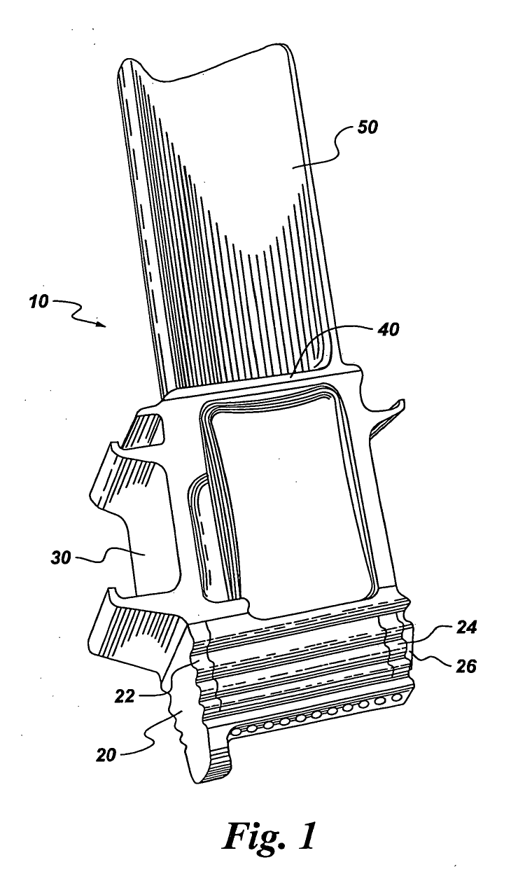

FIG. 1 is a perspective drawing of a turbine engine blade 10, which includes a dovetail 20 that fits in a complementary dovetail slot (not shown) in a perimeter of a disk of a turbine rotor (not shown) for securing the blade thereto. A shank 30 extends radially outwardly from dovetail 20 to a platform 40. An airfoil 50 extends radially outwardly from platform 40 for extracting energy from the combustion gases impinging on airfoil 50, by producing a high-speed rotation of the rotor disk. Strips of aluminum (or aluminum seal strips) are typically disposed on the surface of regions 22, 24, and 26 near the edges of dovetail 20, in the axial direction of the turbine, in order to effect a good seal between dovetail 20 and the dovetail slot in which it is disposed. When turbine blade 20 is removed from the turbine for servicing, it is desirable to remove aluminum seal strips substantially completely from dovetail 20 so that new aluminum seal strips can be deposited or otherwise disposed thereon before reinstallation of turbine blade 20 in the rotor disk.

As mentioned above, the chemical composition for some embodiments of this invention includes an acid having the formula HₓAF₆. In this formula, A is selected from the group consisting of Si, Ge, Ti, Zr, Al, and Ga. The subscript x is a quantity from 1 to 6, inclusive, and more typically, from 1 to 3, inclusive. Materials of this type are available commercially, or can be prepared without undue effort. The preferred acids are H₂SiF₆ or H₂ZrF₆. In some embodiments, H₂SiF₆ is especially preferred and employed in an aqueous medium. H₂SiF₆ is referred to by several alternative names, such as “hydrofluosilicic acid”, “fluorosilicic acid”, “hexafluorosilicic acid”, “dihydrogen hexafluorosilicate”, and “silicofluoric acid”.

Precursors to the HₓAF₆ acid may also be used. As used herein, a “precursor” refers to any compound or group of compounds which can be combined to form the acid or its dianion AF₆⁻², or which can be transformed into the acid or its dianion under reactive conditions, e.g. the action of heat, agitation, catalysts, and the like. Thus, the acid can be formed in situ in a reaction vessel, for example.

As one illustration, the precursor may be a metal salt, inorganic salt, or an organic salt in which the dianion is ionically bound. Non-limiting examples include salts of Ag, Na, Ni, K, and NH₄⁺, as well as organic salts, such as a quaternary ammonium salt. Dissociation of the salts in an aqueous solution yields the acid. In the case of H₂SiF₆, a convenient salt which can be employed is Na₂SiF₆.

Those skilled in the art are familiar with the use of compounds which cause the formation of HₓAF₆ within an aqueous composition. For example, H₂SiF₆ can be formed in situ by the reaction of a silicon-containing compound with a fluorine-containing compound. An exemplary silicon-containing compound is SiO₂, while an exemplary fluorine-containing compound is hydrofluoric acid (i.e., aqueous hydrogen fluoride).

When used as a single acid, the HₓAF₆ acid appears to be quite effective for removing the aluminum-containing coatings or materials disposed on a metal substrate, without adversely affecting the substrate. The term “aluminum-containing” also includes substantially pure aluminum. Moreover, the HₓAF₆ acid also appears to be useful in removing aluminide-type coatings comprising an alloy of aluminum and at least another metal, such as platinum aluminide. The preferred level of acid employed will depend on various factors, such as the type and amount of coating being removed; the location of the coating material on a substrate; the type of substrate; the thermal history of the substrate and coating (e.g., the level of interdiffusion between the coating material and substrate material); the technique by which the substrate is being exposed to the treatment composition (as described below); the time and temperature used for treatment; and the stability of the acid in solution.

In general, the HₓAF₆ acid is present in a treatment composition at a level in the range of about 0.05 M to about 5 M, where M represents molarity. (Molarity can be readily translated into weight or volume percentages, for ease in preparing the solutions.) Usually, the level is in the range of about 0.2 M to about 3.5 M. In the case of H₂SiF₆, a preferred concentration range is often in the range of about 0.2 M to about 2.2 M. Adjustment of the amount of HₓAF₆ acid, and of other components described below, can readily be made by observing the effect of particular compositions on coating removal from the substrate.

In one embodiment of the present invention, the aqueous composition contains at least a second acid, i.e., in addition to the “primary” acid, HₓAF₆. It appears that the use of the second acid sometimes enhances the removal of coating material from less accessible areas of the substrate that are prone to depletion of the acidic solution. A variety of different acids can be used as the second acid, and they are usually characterized by a pH of less than about 7 in pure water. In preferred embodiments, the second acid has a pH of less than about 3.5 in pure water. In some especially preferred embodiments, the additional acid has a pH that is less than the pH (in pure water) of the primary acid, i.e., the HₓAF₆ material. For example, in the case of H₂SiF₆, the second acid is preferably one having a pH of less than about 3, more preferably less than about 2, and most preferably less than about 1.5.

Various types of acids may be used, e.g., a mineral acid or an organic acid. Non-limiting examples include phosphoric acid, nitric acid, sulfuric acid, hydrochloric acid, hydrofluoric acid, hydrobromic acid, hydriodic acid, acetic acid, perchloric acid, phosphorous acid, phosphinic acid, alkyl sulfonic acids (e.g., methanesulfonic acid), and mixtures of any of the foregoing. Those skilled in the art can select the most appropriate second acid, based on observed effectiveness and other factors, such as availability, compatibility with the primary acid, cost, and environmental considerations. Moreover, a precursor of the acid may be used (e.g., a salt), as described above in reference to the primary acid. In some preferred embodiments of this invention, the second acid is selected from the group consisting of phosphoric acid, nitric acid, sulfuric acid, hydrochloric acid, hydrofluoric acid, and mixtures thereof. In some especially preferred embodiments (e.g., when the primary acid is H₂SiF₆), the second acid is phosphoric acid.

The amount of second acid employed will depend on the identity of the primary acid, and on many of the factors set forth above. Usually, the second acid is present in the composition at a level in the range of about 0.1 M to about 20 M. In some preferred embodiments (e.g., in the case of phosphoric acid), the preferred range is from about 0.5 M to about 5 M. Furthermore, some especially preferred embodiments contemplate a range of about 2 M to about 4.5 M. Longer treatment times and/or higher treatment temperatures may compensate for lower concentrations of the second acid, and vice versa. Experiments can be readily carried out to determine the most appropriate concentration for the second acid.

In a preferred embodiment of the present invention, the chemical composition further comprises a third acid. An acid other than phosphoric acid, chosen from among the acids enumerated above, can be used as the third acid. In a preferred embodiment, the third acid is hydrochloric acid.

The amount of third acid employed will depend on the identity of the primary acid, and on many of the factors set forth above. Usually, the third acid is present in the composition at a level in the range of about 0.1 M to about 20 M. In some preferred embodiments (e.g., in the case of hydrochloric acid), the preferred range is from about 0.1 M to about 5 M. Furthermore, some especially preferred embodiments contemplate a range of about 0.5 M to about 2 M. Longer treatment times and/or higher treatment temperatures may compensate for lower concentrations of the third acid, and vice versa. Experiments can be readily carried out to determine the most appropriate concentration for the third acid.

The chemical composition of the present invention may include various other additives, which serve a variety of desirable functions. Non-limiting examples of these additives are inhibitors, dispersants, surfactants, chelating agents, wetting agents, deflocculants, stabilizers, anti-settling agents, and anti-foam agents. Those of ordinary skill in the art are familiar with specific types of such additives, and with effective levels for their use. An example of an inhibitor for the composition is a relatively weak acid like acetic acid, mentioned above. Such a material tends to lower the activity of the primary acid in the composition. This is desirable in some instances, e.g., to decrease the potential for pitting of the substrate surface.

Various techniques can be used to treat the substrate with the aqueous composition. For example, the substrate can be continuously sprayed with the composition, using various types of spray guns. A single spray gun could be employed. Alternatively, a line of guns could be used, and the substrate could pass alongside or through the line of guns (or multiple lines of guns). In another alternative embodiment, the coating removal composition could be poured over the substrate (and continuously recirculated).

In preferred embodiments, the substrate is immersed in a bath of an aqueous composition comprising at least the primary acid, and optionally the second and third acids. In addition, the aqueous composition in the bath may be circulated past the surface of the substrate by, for example, a pumping action. Alternatively, a movement may be imparted to the substrate to effect an agitation for mitigating any depletion of the acids near the surface of the substrate because of the reaction between the acids and the aluminum-containing materials. Immersion and a relative motion between the substrate and the chemical composition in this manner (in any type of vessel) often permits the greatest degree of contact between the aqueous composition and the aluminum-containing coating or material, which is being removed. Immersion time and bath temperature will depend on many of the factors described above, such as the type of coating being removed, and the acid (or acids) being used in the bath. Usually, the bath is maintained at a temperature up to about 100° C., preferably in the range of about 20° C. to about 100° C., while the substrate is immersed therein. In preferred embodiments, the temperature is maintained in the range of about 45° C. to about 90° C. The immersion time may vary considerably, but is usually in the range of about 10 minutes to about 72 hours, and preferably, from about 1 hour to about 20 hours. Longer immersion times may compensate for lower bath temperatures. After removal from the bath (or after contact of the coating by any technique mentioned above), the substrate is typically rinsed in water, which also may contain other conventional additives, such as a wetting agent.

Aluminum-containing coatings on a variety of substrates can be desirably removed according to this invention. Usually, the substrate is a metallic material or a polymeric (e.g., plastic) material. As used herein, “metallic” refers to substrates which are primarily formed of metal or metal alloys, but which may also include some non-metallic components. Non-limiting examples of metallic materials are those which comprise at least one element selected from the group consisting of iron, cobalt, nickel, aluminum, chromium, titanium, and mixtures which include any of the foregoing (e.g., stainless steel).

Very often, the metallic material is a superalloy. Such materials are known for high-temperature performance, in terms of tensile strength, creep resistance, oxidation resistance, and corrosion resistance, for example. The superalloy is typically nickel-, cobalt-, or iron-based, although nickel- and cobalt-based alloys are favored for high-performance applications. The base element, typically nickel or cobalt, is the single greatest element in the superalloy by weight. Illustrative nickel-based superalloys include at least about 40 percent (by weight) Ni, and at least one component from the group consisting of cobalt, chromium, aluminum, tungsten, molybdenum, titanium, and iron. Examples of nickel-based superalloys are designated by the trade names Inconel®, Nimonic®, Rene® (e.g., Rene®80-, Rene®95, Rene®142, and Rene®N5 alloys), and Udimet®, and include directionally solidified and single crystal superalloys. Illustrative cobalt-based superalloys include at least about 30 percent (by weight) Co, and at least one component from the group consisting of nickel, chromium, aluminum, tungsten, molybdenum, titanium, and iron. Examples of cobalt-based superalloys are designated by the trade names Haynes®, Nozzaloy®, Stellite® and Ultimet® In one embodiment, the substrate is a turbine-engine blade, including the airfoil, the shank, and the dovetail.

Polymeric substrates which can be treated by this invention are formed from materials which are substantially acid-resistant. In other words, such materials are not adversely affected by the action of the acid (or acids), to the degree which would make the substrate unsuitable for its intended end use. (Usually, such materials are highly resistant to hydrolysis). Non-limiting examples of such materials are polyolefins (e.g., polyethylene or polypropylene), polytetrafluroethylenes, epoxy resins, polystyrenes, polyphenylene ethers; mixtures comprising one of the foregoing; and copolymers comprising one of the foregoing. (Those skilled in the polymer arts understand that the properties of an individual polymer may be modified by various methods, e.g., blending or the addition of additives.)

The actual configuration of a substrate may vary widely. As a general illustration, the substrate may be in the form of a houseware item (e.g., cookware), or a printed circuit board substrate. In many embodiments, superalloy substrates are in the form of a combustor liners, combustor domes, shrouds, or airfoils. Airfoils, including buckets or blades, and nozzles or vanes, are typical substrates that are stripped according to embodiments of the present invention. The present invention is useful for removing coatings from the flat areas of substrates, as well as from curved or irregular surfaces, which may include indentations, hollow regions, or holes (e.g., film cooling holes).

The method of the present invention may be used in conjunction with a process for repairing protective coatings, which are sometimes applied over the coatings described above. As an example, thermal barrier coatings (TBCs)—often based on zirconia—are frequently applied over aluminide coatings or MCrAl(X)-coatings, to protect turbine engine components from excessive thermal exposure. The periodic overhaul of the TBC sometimes requires that any underlying layers also be removed. The TBC can be removed by various methods, such as grit blasting or chemical techniques. The underlying coating or multiple coatings can then be removed by the process described above. The component can subsequently be conventionally re-coated with the aluminide and or MCrAl(X) coating, followed by standard re-coating with fresh TBC.

Another embodiment of this invention is directed to an aqueous composition for selectively removing aluminum seal strips from the surface of the dovetail of a turbine blade. Such a removal is desirable during a refurbishment or servicing of a turbine-engine blade so that new aluminum seal strips may be applied on the dovetail of the refurbished blade for better reattachment of the turbine-engine blade into the corresponding dovetail slot. As described previously, the composition includes an acid having the formula HₓAF₆, or precursors for said acid, wherein A is selected from the group consisting of Si, Ge, Ti, Zr, Al, and Ga; and x is 1-6, inclusive. The acid is usually present in the composition at a level in the range of about 0.05 M to about 5 M.

In a preferred embodiment, the composition includes at least a second acid or precursor thereof, and a third acid or precursor thereof. The second acid is preferably phosphoric acid present in the composition at a concentration in the range of about 0.1 M to about 20 M, and preferably, in the range of about 0.5 M to about 5 M. The third acid is preferably hydrochloric acid present in the composition at a concentration in the range from about 0.1 M to about 5 M, and preferably, in the range from about 0.5 M to about 2 M.

### EXAMPLE

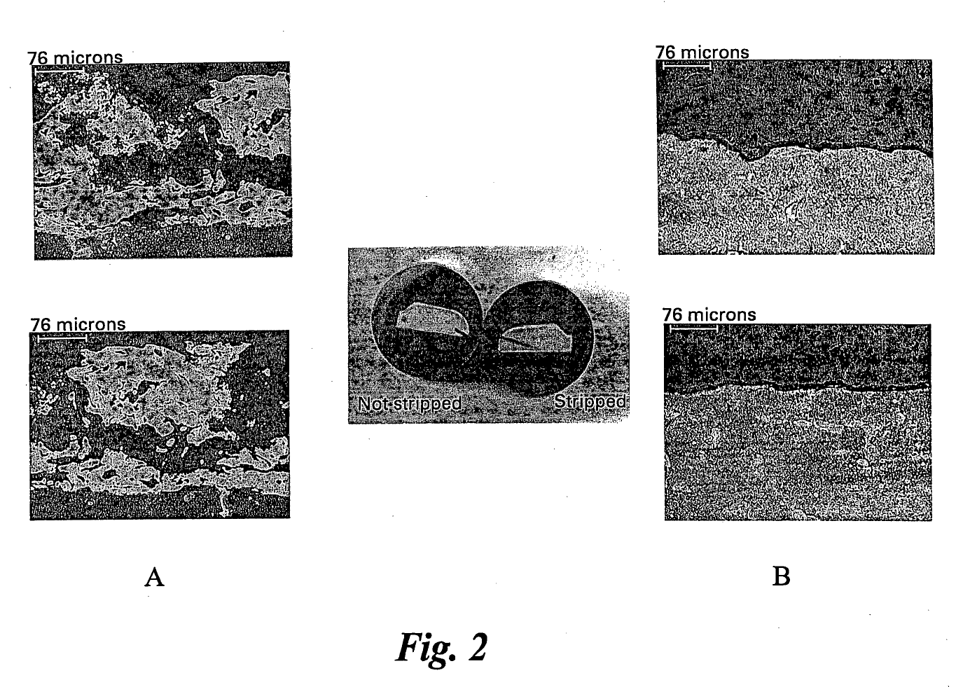

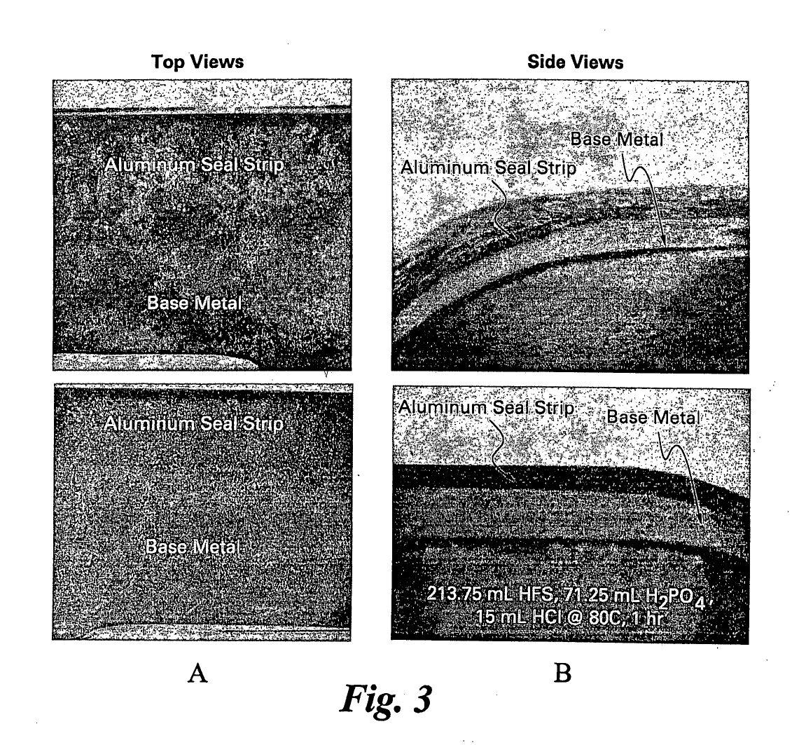

A section of a dovetail having aluminum seal strips was cut from a used turbine engine blade, which was made of a nickel-based superalloy. The section was immersed in an aqueous acid solution that comprises 71.25 percent (by volume) of a hydrofluorosilicic acid solution (acid concentration of about 23 percent by weight, specific gravity of about 1.22), 23.75 percent (by volume) of a phosphoric acid solution (acid concentration of about 85 percent by weight, specific gravity of about 1.68), and 5 percent (by volume) of a hydrochloric acid solution (nominal acid concentration of about 36.5-38 percent by weight, specific gravity of about 1.18). The aqueous acid mixture and the section immersed therein were kept at about 80° C. for about 1 hour. The section was rotated at 500 rpm in the solution. FIGS. 2A and 2B show scanning electron micrographs of the section before and after acid treatment. A comparison of FIGS. 2A and 2B reveals that the aluminum portion on the substrate was substantially completely removed.

While various embodiments are described herein, it will be appreciated from the specification that various combinations of elements, variations, equivalents, or improvements therein may be made by those skilled in the art, and are still within the scope of the invention as defined in the appended claims.

1. A chemical composition comprising a first compound selected from the group consisting of an acid having a formula of HₓAF₆, a precursor thereof, and a mixture of said acid and said precursor; wherein A is selected from the group consisting of Si, Ge, Ti, Zr, Al, and Ga; and x is in a range from 1 to 6, inclusive; said chemical composition is capable of reacting selectively with an aluminum-containing material.

2. The chemical composition according to claim 1, wherein said first compound is present at a concentration from about 0.05 M to about 5 M.

3. The chemical composition according to claim 1, wherein said first compound is present at a concentration from about 0.2 M to about 3.5 M.

4. The chemical composition according to claim 1, further comprising at least a second compound selected from the group consisting of phosphoric acid, nitric acid, sulfuric acid, hydrochloric acid, hydrofluoric acid, hydrobromic acid, hydriodic acid, acetic acid, perchloric acid, phosphorous acid, phosphinic acid, alkyl sulfonic acids, and mixtures thereof.

5. The chemical composition according to claim 4, wherein said at least second compound is phosphoric acid.

6. The chemical composition according to claim 5, wherein said at least second compound is present at a concentration from about 0.1 M to about 20 M.

7. The chemical composition according to claim 5, wherein said at least second compound is present at a concentration from about 0.5 M to about 5 M.

8. The chemical composition according to claim 5, further comprising a third compound that comprises hydrochloric acid.

9. The chemical composition according to claim 8, wherein said third compound is present at a concentration from about 0.1 M to about 20 M.

10. The chemical composition according to claim 5, wherein said third compound is present at a concentration from about 0.5 M to about 2 M.

11. The chemical composition according to claim 10, wherein said chemical composition is an aqueous solution of said first compound, said second compound, and said third compound.

12. A method for selectively removing an aluminum-containing material from a work piece, wherein said work piece comprises a substrate on which said aluminum-containing material is disposed, said method comprising contacting said work piece with a chemical composition that comprises a first compound selected from the group consisting of an acid having a formula of HₓAF₆, a precursor thereof, and a mixture of said acid and said precursor; wherein A is selected from the group consisting of Si, Ge, Ti, Zr, Al, and Ga; and x is in a range from 1 to 6, inclusive; said chemical composition is capable of reacting selectively with an aluminum-containing material.

13. The method according to claim 12, wherein said chemical composition further comprises a second compound selected from the group consisting of phosphoric acid, nitric acid, sulfuric acid, hydrochloric acid, hydrofluoric acid, hydrobromic acid, hydriodic acid, acetic acid, perchloric acid, phosphorous acid, phosphinic acid, alkyl sulfonic acids, and mixtures thereof.

14. The method according to claim 12, wherein said second compound is phosphoric acid.

15. The method according to claim 12, wherein said chemical composition further comprises a third compound that comprises hydrochloric acid.

16. The method according to claim 12, wherein said first compound is present at a concentration in a range from about 0.05 M to about 5 M.

17. The method according to claim 12, wherein said first compound is present at a concentration in a range from about 0.2 M to about 3.5 M.

18. The method according to claim 14, wherein said second compound is present at a concentration in a range from about 0.1 M to about 20 M.

19. The method according to claim 14, wherein said second compound is present at a concentration in a range from about 0.5 M to about 5 M.

20. The method according to claim 15, wherein said third compound is present at a concentration in a range from about 0.1 M to about 20 M.

21. The method according to claim 15, wherein said third compound is present at a concentration in a range from about 0.5 M to about 2 M.

22. A method for selectively removing an aluminum-containing material from a work piece, wherein said work piece comprises a substrate on which said aluminum-containing material is disposed, said method comprising contacting said work piece with a chemical composition that comprises an acid having a formula of H₂SiF₆, phosphoric acid, and hydrochloric acid; said chemical composition is capable of reacting selectively with an aluminum-containing material; wherein said H₂SiF₆ is present at a concentration in a range from about 0.05 M to about 5 M, said phosphoric acid is present at a concentration in a range from about 0.1 M to about 20 M, and said hydrochloric acid is present at a concentration in a range from about 0.1 to about 20 M.

23. The method according to claim 22, wherein a motion is imparted to said work piece relative to said chemical composition.

24. The method according to claim 22, wherein a motion is imparted to said chemical composition relative to said work piece.

25. The method according to claim 22, wherein both said chemical composition and said work piece are maintained at a temperature up to about 100° C., and said contacting is carried out for a time from about 10 minutes to about 72 hours.

26. The method according to claim 22, wherein said work piece is a turbine-engine blade, and said aluminum-containing material comprises aluminum seal strips disposed on a dovetail of said turbine-engine blade.

27. The method according to claim 26, wherein said turbine-engine blade comprises a material selected from the group consisting of nickel-, cobalt-, and iron-based alloys.
